(19) United States
(12) Patent Application Publication
(10) Pub. No.: US 2017/0341590 A1
(43) Pub. Date: Nov. 30, 2017

(54) ROOF RACK FOR A VEHICLE

(71) Applicant: MARK MCLAUCHLAN, AUCKLAND (NZ)

(72) Inventor: MARK MCLAUCHLAN, AUCKLAND (NZ)

(21) Appl. No.: 15/596,683

(22) Filed: May 16, 2017

(30) Foreign Application Priority Data
May 27, 2016 (NZ) 720598

(51) Int. Cl. B60R 9/042; B60R 9/058; B60R 9/048

(52) U.S. Cl. CPC B60R 9/042; B60R 9/048; B60R 9/058

(57) ABSTRACT

Disclosed is a roof rack for a vehicle having:
roof attachment means;
a cargo frame adapted to releasably engage with cargo;
means to enable the cargo frame to be moved between a substantially horizontal position above the roof of a vehicle and a substantially vertical position behind the vehicle; and
means to control the rate of descent or ascent of the cargo frame;
   the roof rack adapted such that in use the roof rack is attached to the roof of a vehicle via the roof attachment means and wherein a user standing behind the vehicle is able to pull the cargo frame or attached cargo towards himself such that the cargo frame and attached cargo controllably moves from a substantially horizontal position above the roof of the vehicle to a substantially vertical position behind the vehicle so that the user can load and/or unload the cargo and once this is done the user can push the cargo frame or attached cargo such that the frame controllably moves from a substantially vertical position behind the vehicle to a substantially horizontal position above the roof of the vehicle.

### FIELD OF INVENTION

The invention generally relates to a roof rack of a vehicle. More particularly but not exclusively the invention relates to roof rack which is loaded and unloaded at the rear of a vehicle.

### BACKGROUND

Roof racks typically consist of a set of bars mounted to the roof of a vehicle and are used to carry items such as skis, kayaks, canoes and luggage etc. Many sports utility vehicles and vans etc have high road clearance and high roofs, which makes it difficult to stow and retrieve items from roof racks on these vehicles.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in the United States of America or in any other country.

The term “comprising” and derivatives thereof, e.g. “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided roof rack for a vehicle having:
roof attachment means (e.g. a platform and clamps or clamps);
a cargo frame adapted to releasably engage with cargo (e.g. a cargo box containing equipment, luggage or sporting equipment etc);
means to enable the cargo frame to be moved between a substantially horizontal position above the roof of a vehicle (e.g. a travelling position) and a substantially vertical position behind the vehicle (e.g. a loading or unloading position); and
means to control the rate of descent or ascent of the cargo frame;

the roof rack adapted such that in use the roof rack is attached to the roof of a vehicle via the roof attachment means and wherein a user standing behind the vehicle is able to pull the cargo frame or attached cargo towards himself such that the cargo frame and attached cargo controllably moves from a substantially horizontal position above the roof of the vehicle to a substantially vertical position behind the vehicle so that the user can load and/or unload the cargo and once this is done the user can push the cargo frame or attached cargo such that the frame controllably moves from a substantially vertical position behind the vehicle to a substantially horizontal position above the roof of the vehicle.

Preferably the substantially vertical position of the cargo frame is between about 60 degrees and about 90 degrees.

Preferably the substantially vertical position of the cargo frame is about 70 degrees.

Preferably the means to control the rate of descent or ascent is controlled by a tilt and load control assembly.

Preferably the means to control the rate of descent or ascent is controlled by a tilt and load control assembly which comprises at least two tilt arms, at least one tilt guide, at least one gas spring and at least one hydraulic damper.

Preferably the cargo frame has at least one clamp which enables it to releasably engage with the cargo.

Preferably the roof attachment means comprises a platform having at least two clamps which clamp to the roof or roof rails of a vehicle.

Preferably the roof attachment means comprises a platform having four clamps which clamp to the roof rails of a vehicle.

Preferably the roof attachment means comprises a platform having two elongate members which run lengthwise of the roof of the vehicle when installed and also having two elongate members connecting the lengthwise elongate members and further having four clamps attached to the lengthwise elongate members which clamp to the roof rails of a vehicle.

Preferably the cargo frame comprises two elongate members which run lengthwise of the roof of the vehicle when installed and also having three elongate members connecting the lengthwise members and also having cargo attaching means.

Preferably the roof rack has a rear lock assembly which when locked prevents the cargo frame from moving.

Preferably the roof rack has a rear lock assembly which when locked prevents the cargo frame from moving, the rear lock assembly comprising at least one jump-stopper, at least one hook-lock, at least one cam and at least one drop lock.

Preferably the cargo comprises cargo comprises a cargo box which houses equipment (e.g. sports gear, luggage etc) and is adapted such that it can be moved between an open configuration and a closed configuration.

These and other features, objects and advantages of the present invention will be readily apparent to persons of ordinary skill in the art upon reading the entirety of this disclosure, which includes the accompanying drawings and claims.

### BRIEF DESCRIPTION OF THE DRAWINGS

Some preferred embodiments of the invention will now be described by way of example and with reference to the accompanying drawings, of which:

FIG. 1 is a side view of a roof rack carrying cargo and when installed on a vehicle;

FIG. 2 is a top perspective view of a platform which forms part of the roof rack;

FIG. 3 is a side perspective view of a rail clamp which forms part of the roof rack;

FIG. 4 is a top perspective view of a carrier which forms part of the roof rack;

FIG. 5 is a top perspective view of a disassembled tilt and load assembly which forms part of the roof rack;

FIG. 6 is a side view of the tilt and load assembly shown in FIG. 5 when assembled;

FIG. 7 is a side perspective view the assembly shown in FIG. 6 when attached to the carrier shown in FIG. 4;

FIG. 8 is an end perspective view of the assembly and carrier shown in FIG. 7;

FIG. 9 is a top perspective view of the platform and a cargo frame;

FIG. 10 is a top perspective view of the platform and cargo frame when connected;

FIG. 11 is top view of the rear lock assembly when disassembled which forms part of the roof rack;

FIG. 12 is a side perspective view of the rear lock assembly when assembled and being unlocked;

FIG. 13 is a side perspective view of the rear lock assembly when assembled and being unlocked;

FIG. 14 is a side perspective view of the rear lock assembly when assembled and being unlocked;

FIG. 15 is an end perspective view of the rear lock assembly when unlocked and wherein the carriers have been slid forward;

FIG. 16 is a top perspective view of a zee-lock which forms part of the roof rack;

FIG. 17 is a side perspective view of a zee-lock when locked and preventing the cargo frame from moving;

FIG. 18 is a side perspective view of the zee-lock when unlocked;

FIG. 19 is an end perspective view of a pivot guide and a rear tilt guide attached to a carrier with a cargo frame running through it;

FIG. 20 is a side perspective view of the tilt arms which form part of the roof rack when closed;

FIG. 21 is a side perspective view of the tilt arms when open;

FIG. 22 is a side perspective view of stoppers attached to the end of the cargo frame and forward pivot guides which are attached to the tilt arms;

FIG. 23 is a top perspective view of forward pivot guides and a tilt arm which form part of the roof rack;

FIG. 24 is a side view of the roof rack when in use when the cargo frame is being pulled out from the back;

FIG. 25 is a side view of the roof rack when in use when the cargo frame is being tilted from a horizontal to a vertical position;

FIG. 26 is a side view of the roof rack when the cargo frame is in a substantially vertical loading/unloading position;

FIG. 27 is a side view of the roof rack when in use when the cargo frame is being tilted from a substantially vertical to a horizontal position; and

FIG. 28 is a side view of the roof rack when in use when the cargo frame is in a horizontal travelling position.

### DETAILED DESCRIPTION

In a preferred embodiment the invention there is provided a roof rack for a vehicle. References to vehicle throughout the specification relate to any type of motor car such as a sports utility vehicle, van, station wagon, truck etc.

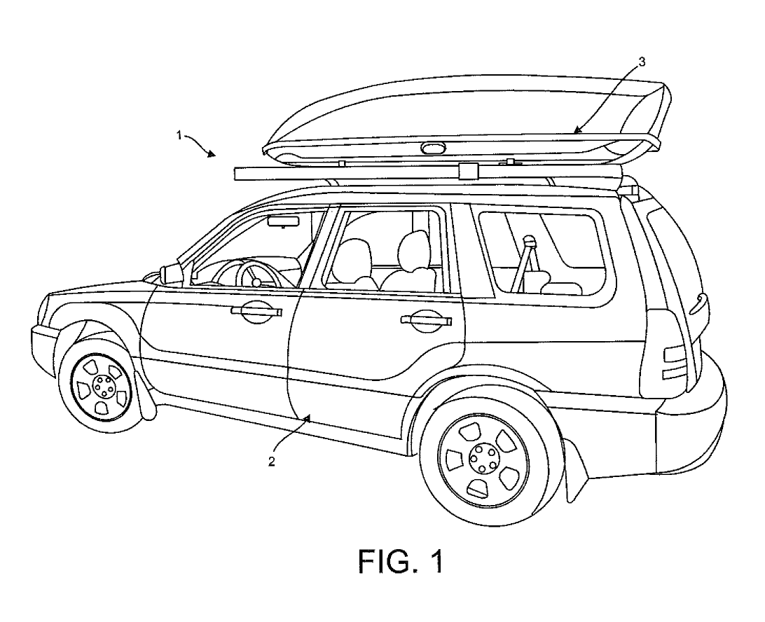

FIG. 1 shows a roof rack 1 which has been installed on the roof of a vehicle 2. As can be seen the roof rack 2 has a cargo box 3 attached to it however those skilled in the art will appreciate that other cargo items such as sport equipment (e.g. skis, bicycles and golf equipment etc) can be attached to the roof rack 1 instead of a cargo box 3. References throughout the specification to cargo relates to anything being transported on the roof rack and includes the cargo box 3 (which can be opened and closed) and what is housed within the cargo box e.g. luggage, sports gear etc.

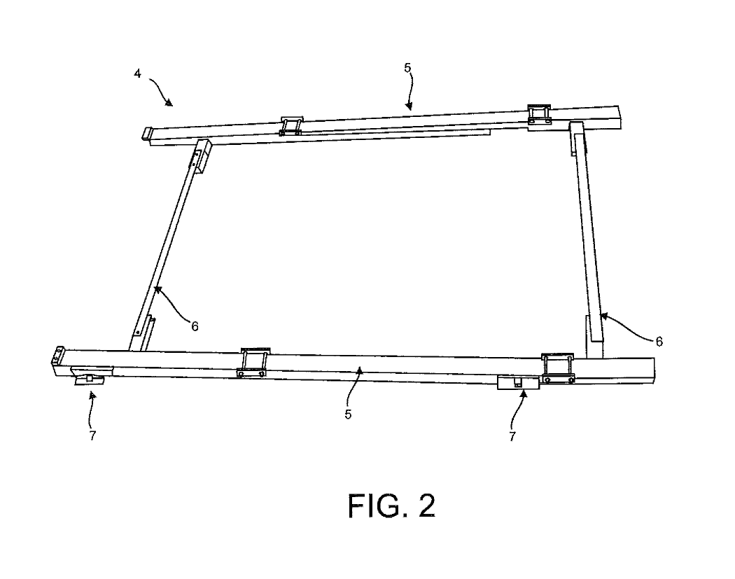

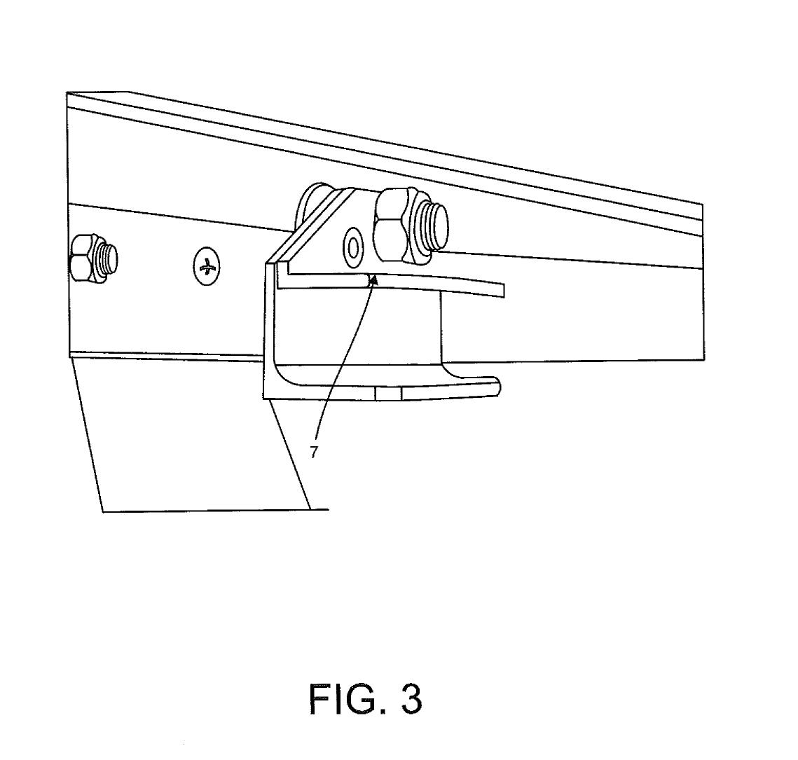

FIG. 2 shows a platform 4 which forms part of the roof rack 1. As can be seen the platform 4 has two elongate members 5 which when installed run lengthwise along the roof of a vehicle 2 and two connecting elongate members 6 which run perpendicular to the lengthwise members 5. The platform also has four rail to rack clamps 7, one of which is shown in more detail in FIG. 3. These clamps 7 are attached to a vehicle's roof rail (not shown) in use. The clamps 7 shown are designed for a Subaru Forester™ however those skilled in the art will appreciate that they can be adapted to other models of vehicles and that the number of clamps 7 can vary. In some embodiments the apparatus 1 does not have a platform 4 as other forms of attachment to the vehicle 2 can be used. Those skilled in the art will also appreciate that instead of using the clamps 7 shown in the drawing any other suitable type of means of attachment of the roof rack to a vehicle can be used for example clamping to roof rack cross bars (with a plate and bolt set) etc.

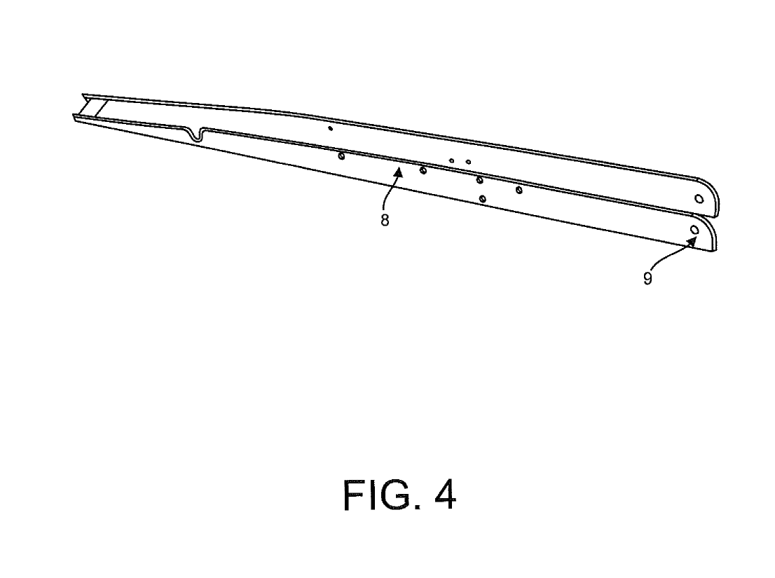

Shown in FIG. 4 is a carrier 8. This carrier 8 and a second carrier which is not shown in this figure sits squarely on top of the platform 4 when installed and its end 9 extends no further than the hinge of a vehicle's 2 hatch back door (not shown).

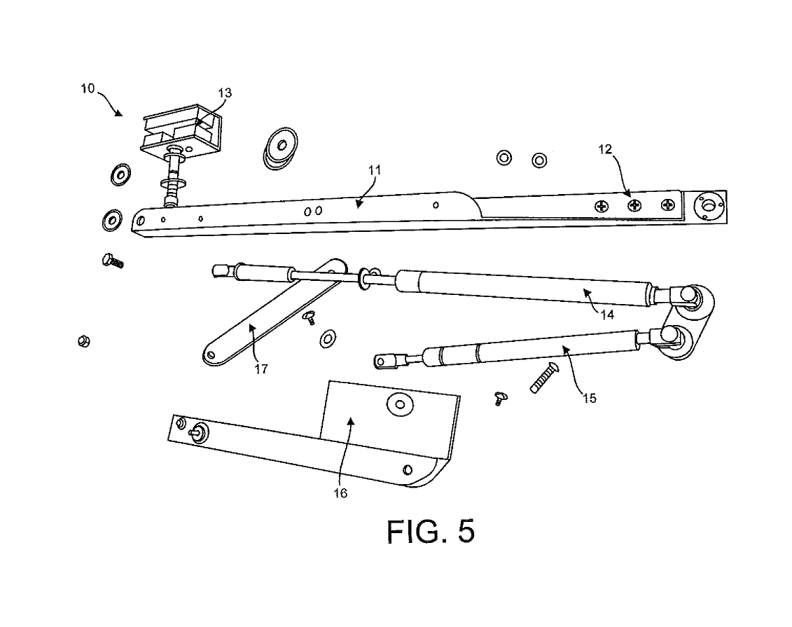

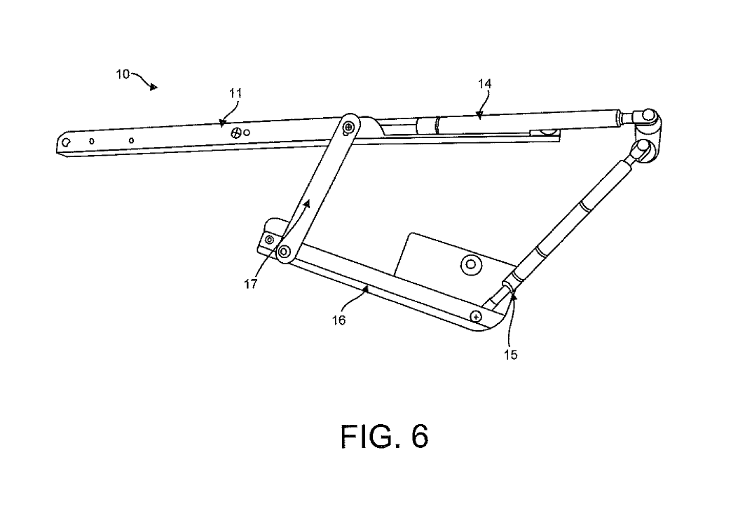

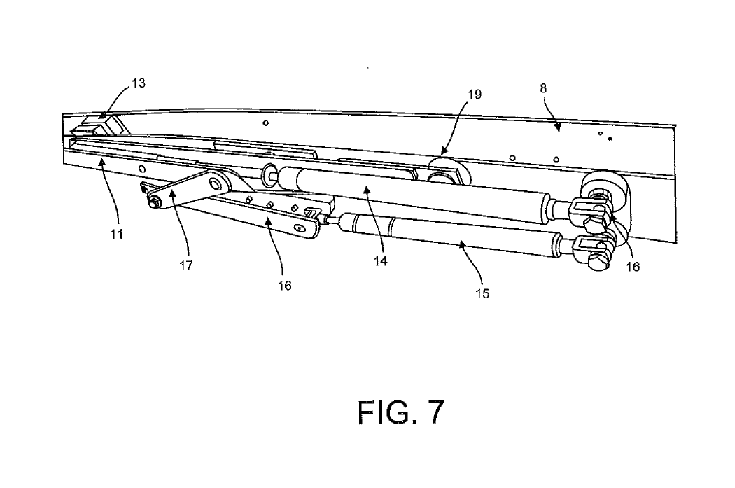

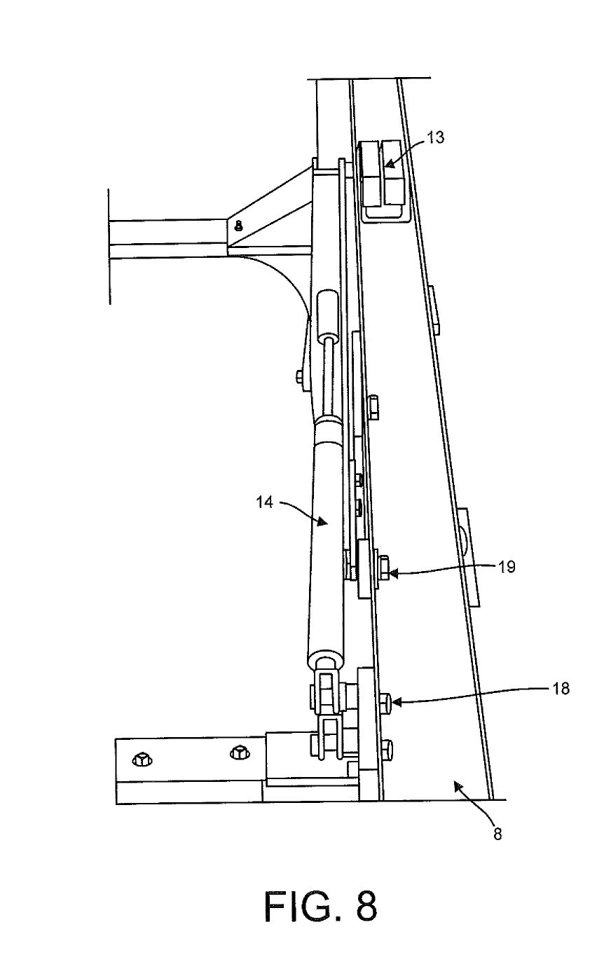

FIG. 5 shows a disassembled load and tilt control assembly 10. There are preferably two of these assemblies 10 and each is attached to a carrier 8 when in use. The assembly 10 has a tilt (or pivot) arm 11, a tilt guide 12 at one end and a T-nut swivel 13 at the other end. The assembly 10 also has a gas spring 14, a hydraulic ram or damper 15, a second tilt (or pivot) arm 16 and pivoting member 17. FIG. 6 shows the assembly 10 when assembled and FIGS. 7 and 8 shows the assembly 10 when connected to the carrier 8. As can be seen one end of the springs 14 and dampers 15 are attached to the carrier 8 by bolts of the like 18 and the tilt arm 11 is also connected to the carrier 8 via the T-nut swivel 13 and by bolts of the like 19.

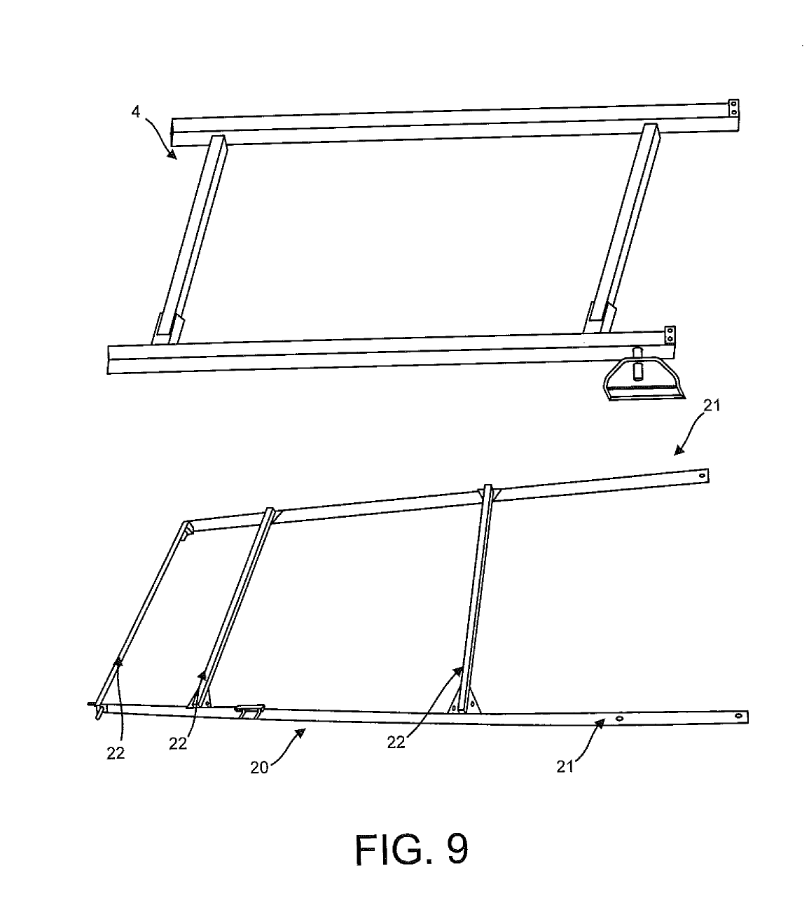

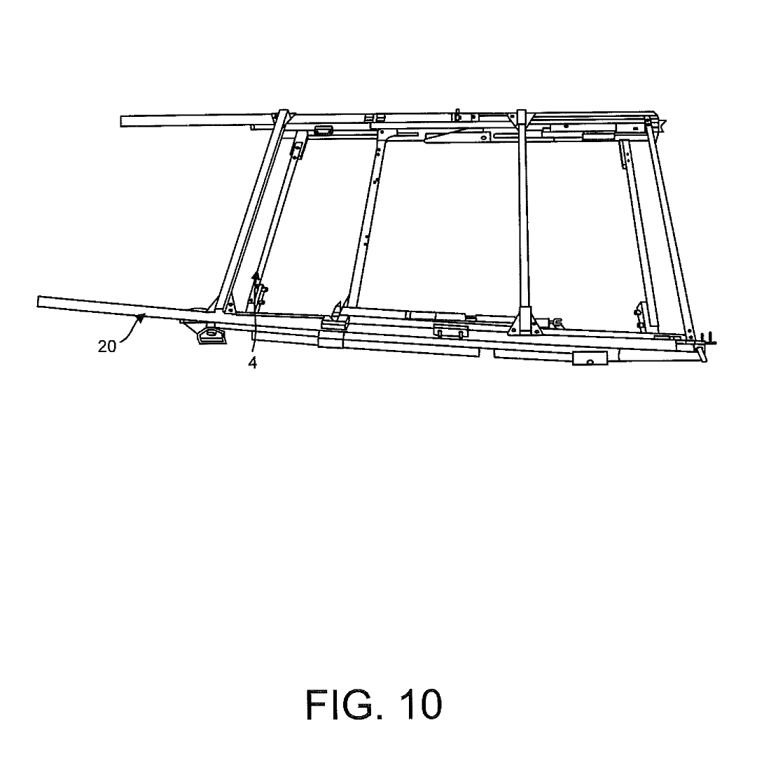

FIGS. 9 and 10 show a cargo frame 20. In FIG. 9 the frame 20 is next to platform 4 and in FIG. 10 the frame 20 sits on top of the carriers 8 which are on top of the platform 4. The frame 20 has two elongated members 21 which run lengthwise of a vehicle 2 when installed and three members 22 which are perpendicular to them. Items such as skis, bikes and cargo boxes 3 are attached to the cargo frame 20 when in use with clamps (not shown) or with other attachment types of means.

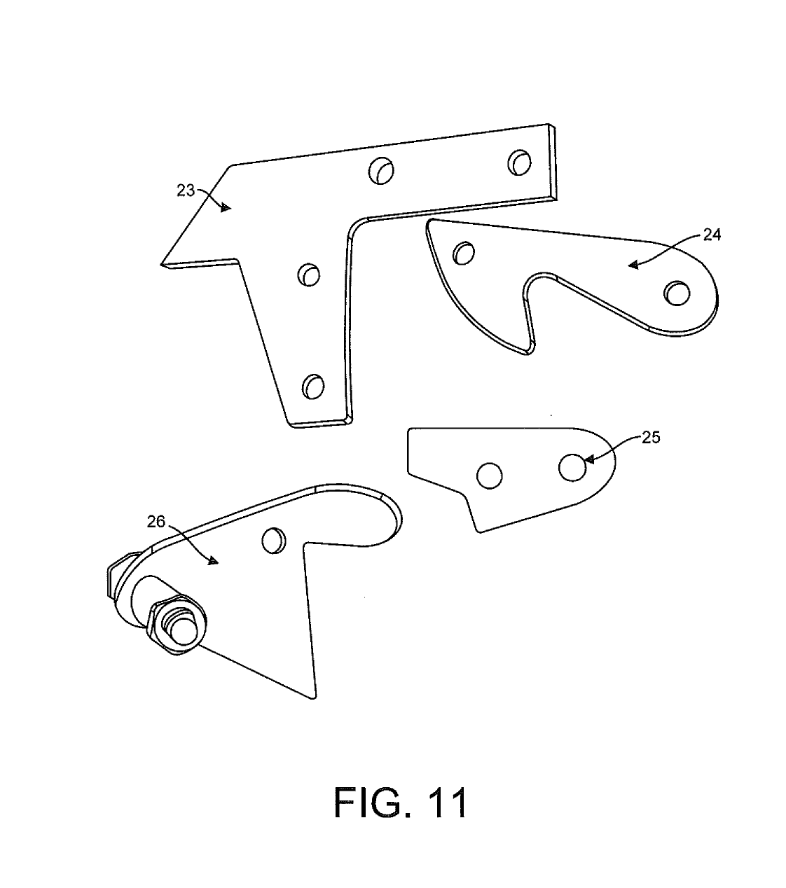

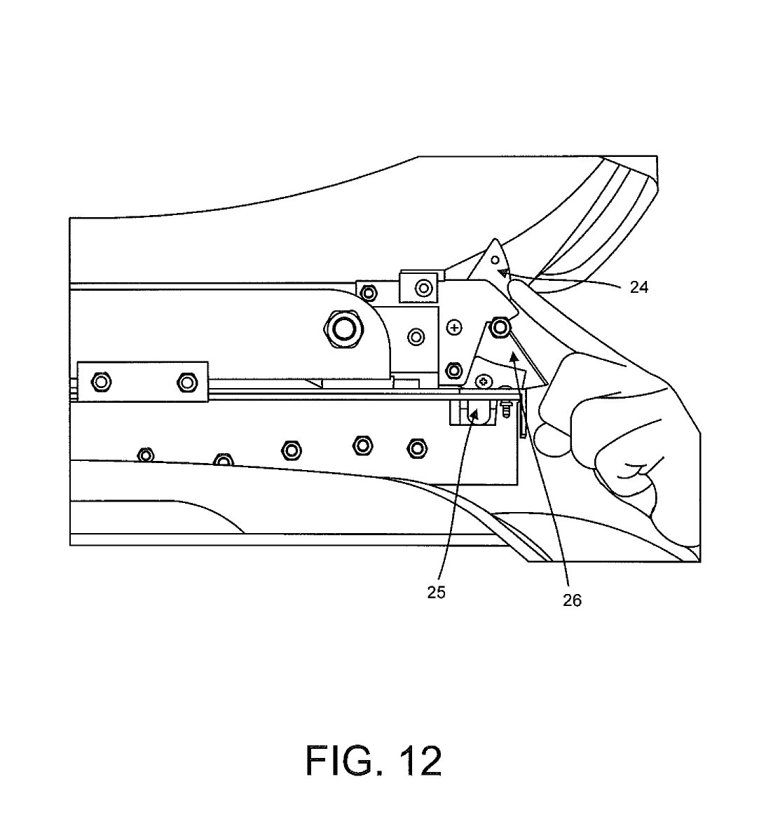

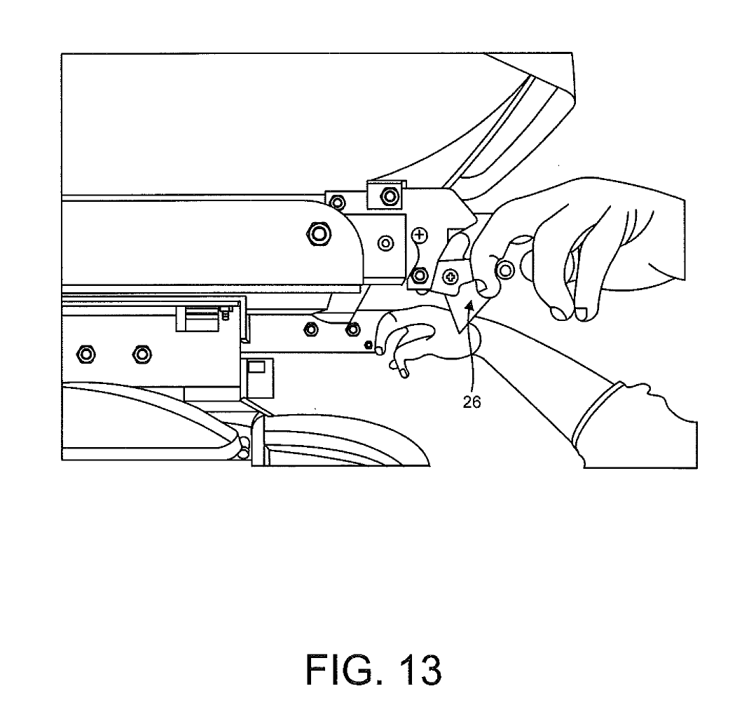

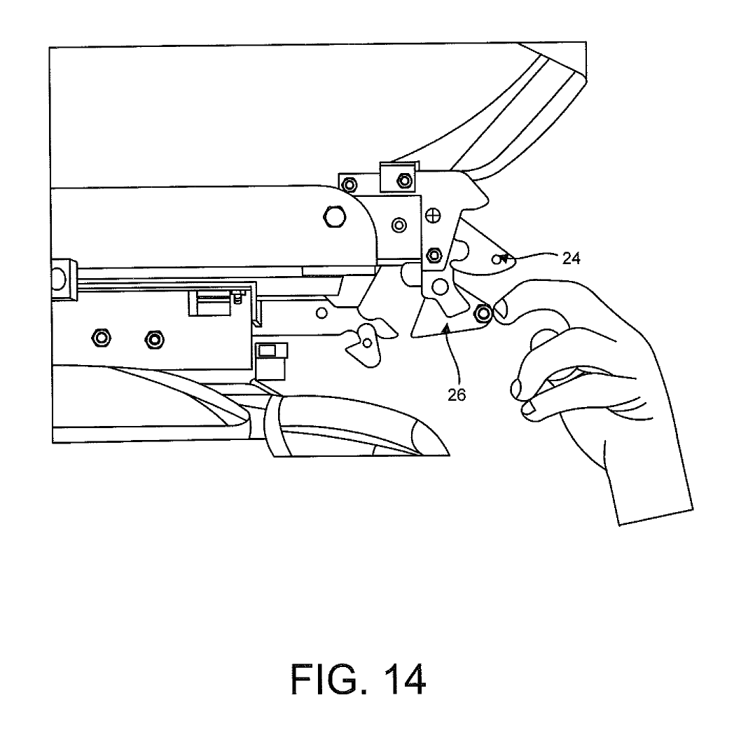

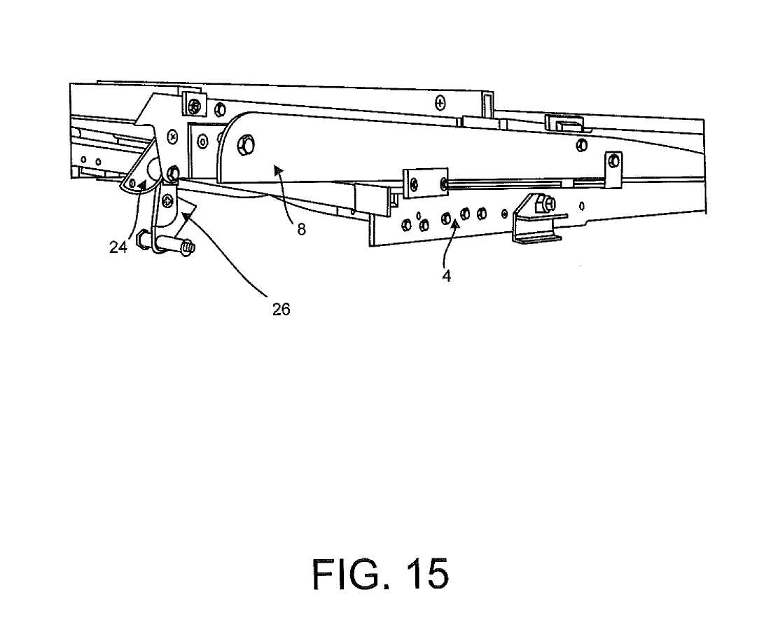

The platform 4, carriers 8, and the frame 20 are held together in their travelling or home position by a rear lock assembly shown in FIG. 11 which comprises a jump-stopper 23, a hook-lock 24, a cam 25 and a drop lock 26. FIGS. 12, 13 and 14 shows rear two locking assemblies when assembled and a user unlocking it. Firstly the hook-locks 24 are lifted by a user. Then the drop-locks 26 are pulled back. This causes the cams 25 to lift and rotate the drop-lock sear to lift and rotate, freeing itself from an aperture or slot in the platform (not visible). When the rear lock assembly is unlocked the carriers 8 are able to slide to the rear and lock about 9 inches beyond the rear of the vehicle and platform 4 as shown in FIG. 15.

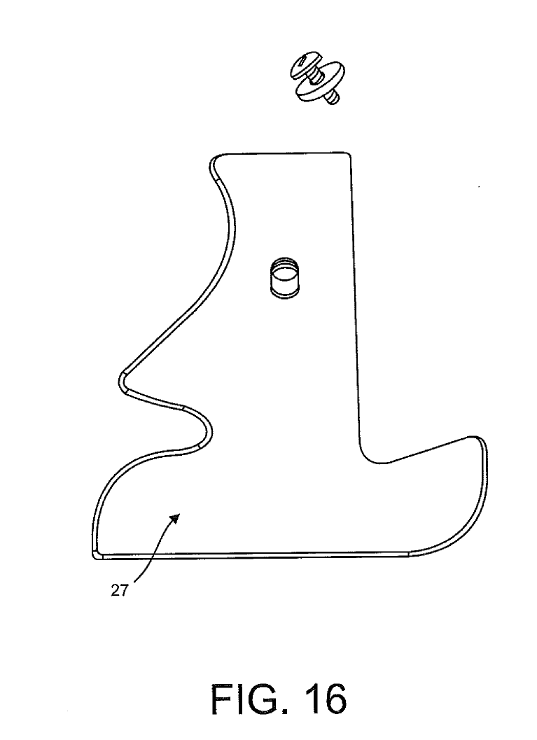

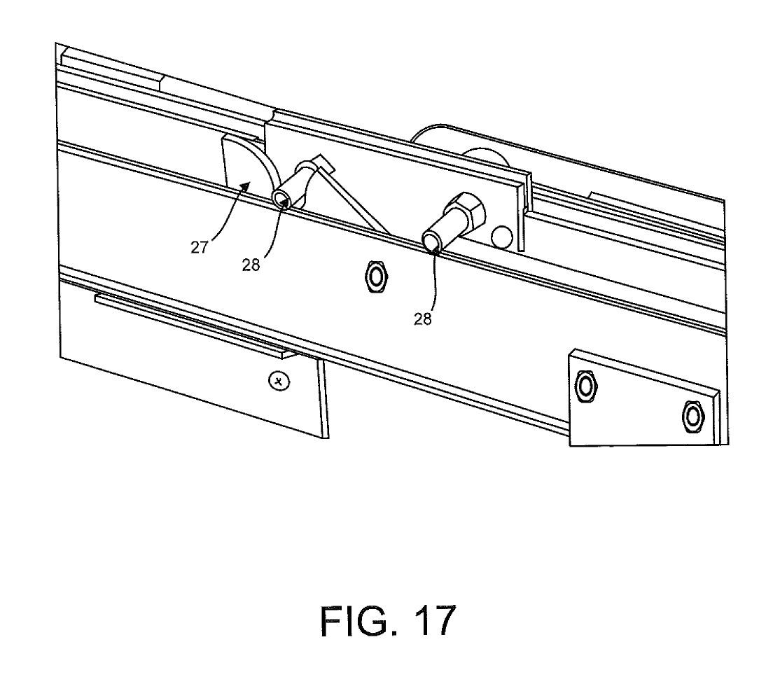

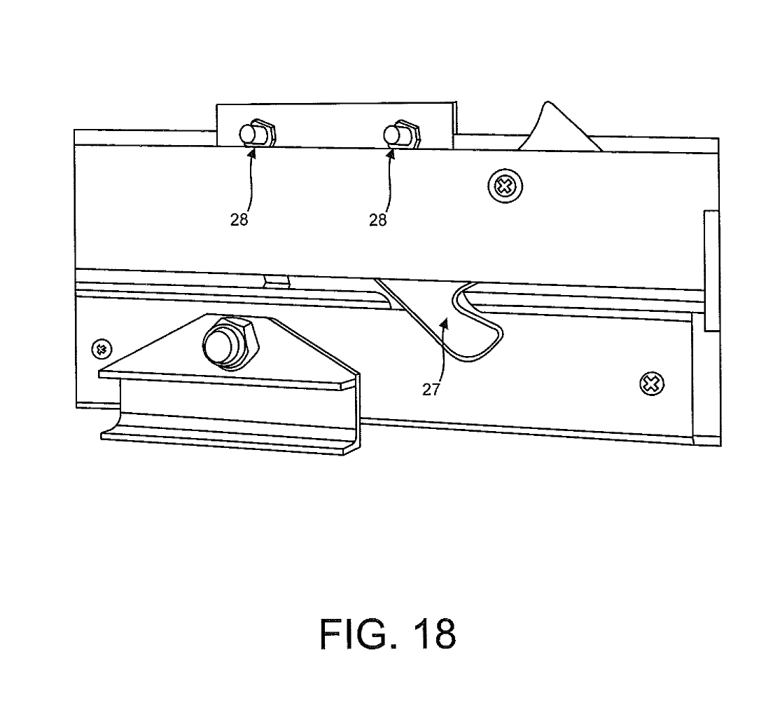

FIG. 16 shows a zee-lock 27. As shown in FIG. 17 the carriers 8 has two male members (e.g. bolts) 28 one of which engages into a locking relationship with zee-lock 27. When in this locking relationship it prevents the carriers 8 from accidentally sliding back as the weight of the cargo box 3 moves to the rear so that the cargo box 3 cannot crash into the back of the vehicle 2. FIG. 18 shows when the members 28 and zee lock 27 are not in a locking relationship. When in this unlocked relationship the carrier is locked in its rear position and allows the cargo frame 20 to move to the rear. Those skilled in the art will appreciate that instead of the locking system shown in the drawings an alternative locking system can be used for example a garden gate latch type locking system could be used.

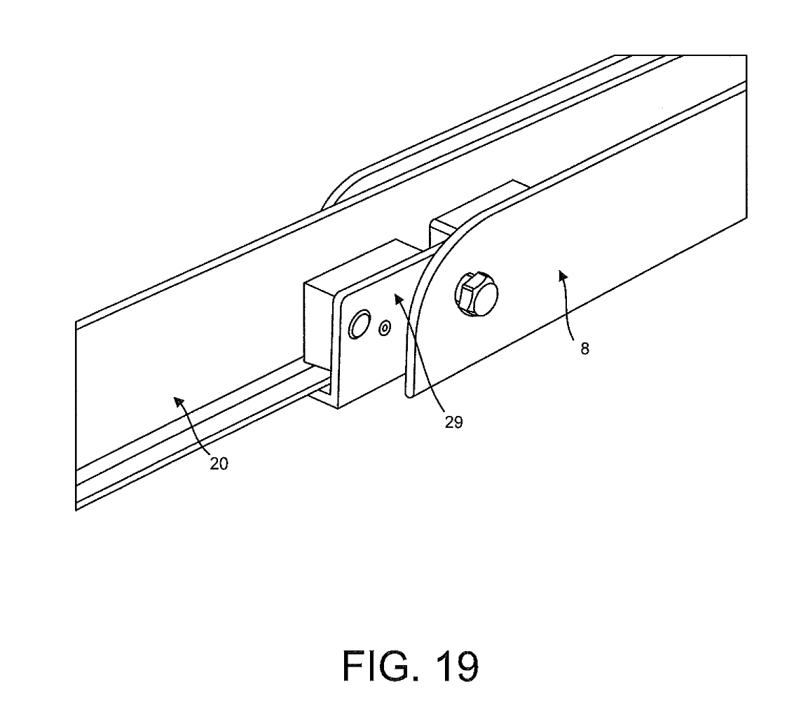

As can be seen in FIG. 19 the carrier 8 has a rear tilt pivot guide 29 attached (e.g. by fasteners or the like) to it which has the cargo frame 20 running through it.

In use once the carriers 8 are deployed to the rear and locked in place, the cargo frame 20 can be pulled to the rear of the vehicle 2. When the cargo boxes 3 centre of mass moves to the rear and passes the fulcrum of the pivot guides 29, the cargo frame 20 tilts from horizontal towards about 70 degrees vertical. Those skilled in the art will appreciate that references to substantially vertical throughout the specification relate to between about 60 degrees to about 90 degrees. As the cargo frame 20 tilts, the rate of descent is controlled by the tilt and load control assembly 10.

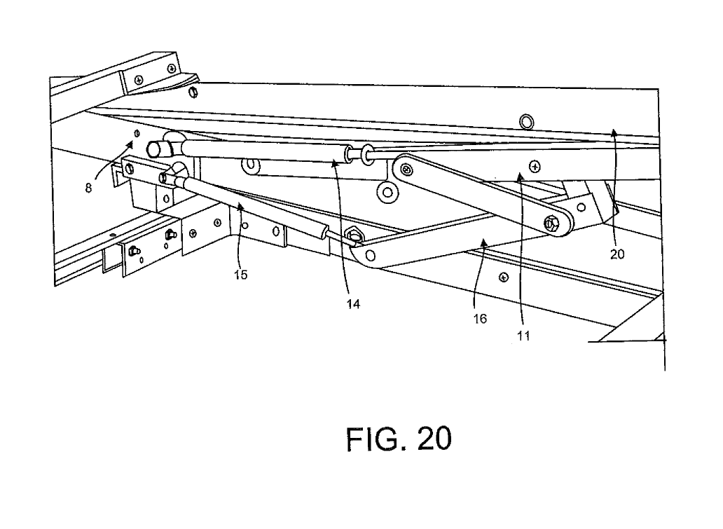

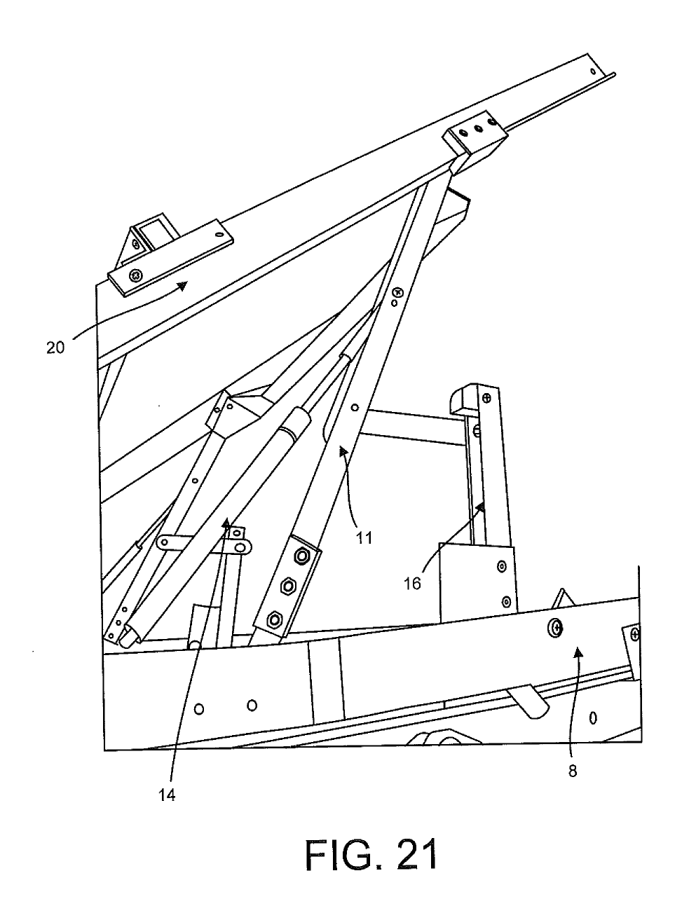

FIGS. 20 and 21 shows that the gas springs 14 and hydraulic dampers 15 are attached at one end to two separate tilt arms 11 and 16 which guide the cargo frame 20 as it arcs from horizontal towards vertical. The other ends of the springs 14 are attached to the carriers 8 as are the other end of the arms 11, 16.

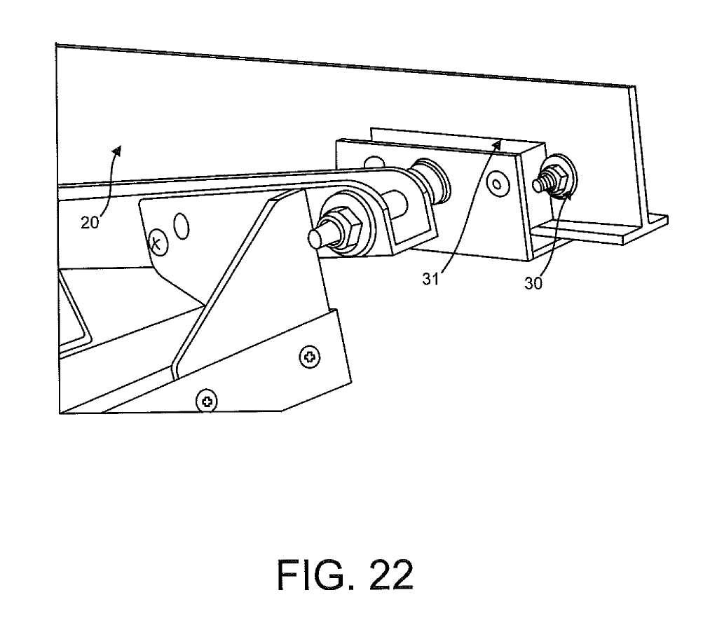

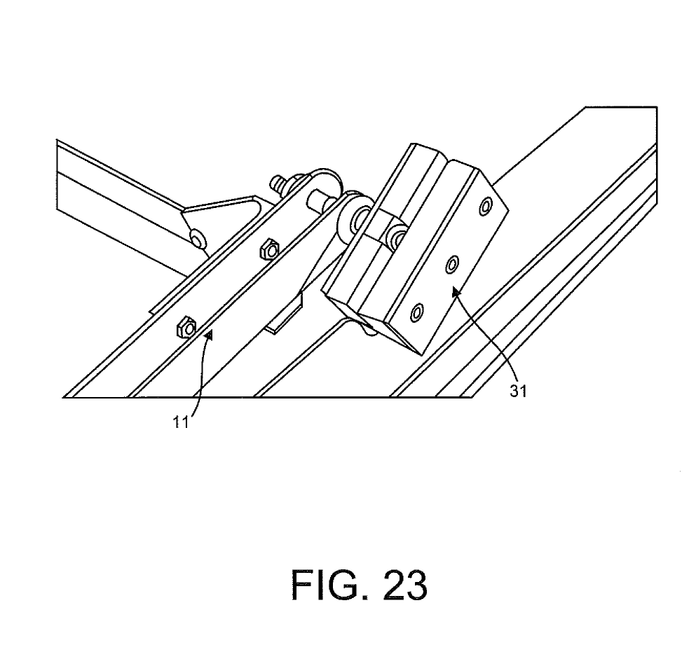

FIG. 22 shows stoppers 30 at the end of the cargo frame 20. These stoppers 30 stop the cargo boxes 3 descent when in use when the stoppers 30 reach a set of forward pivot guides 31 which are attached to the tilt arm 11 as shown in FIG. 23. In use once the cargo box 3 has been un/loaded, the user gives the cargo frame 20 a gentle push, and with the assistance of the gas springs 14, it rises up until the cargo's 3 centre of mass reaches the fulcrum point and begins to tilt toward horizontal. To prevent the load from crashing onto the vehicle's roof, a pair of hydraulic dampers 15 arrest the rate of tilt from vertical to horizontal. Once fully horizontal, the cargo frame 20 is pushed forward toward their travelling or home position. Lugs on the cargo frame 20 disengage the zee-locks 27, which allow the carriers 8 to also move forward. Once the carriers 8 and the cargo frame 20 reach the travelling or home position, drop-locks attached to the end of the cargo frame 20 drop automatically into place. For double security, hook-locks 24 are automatically deployed to prevent any possibility of the drop-locks 26 from disengaging. Those skilled in the art will appreciate that instead of the locking system shown in the drawings an alternative locking system can be used for example a garden gate latch type locking system could be used.

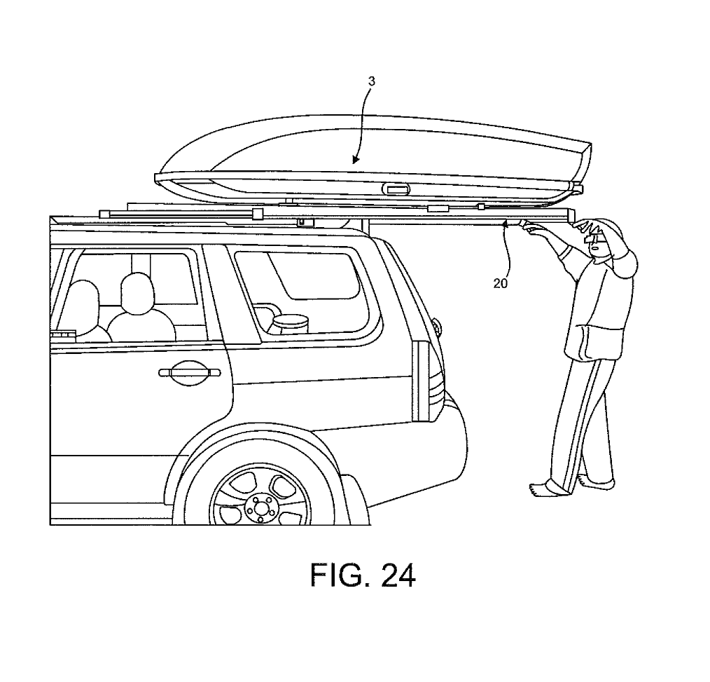

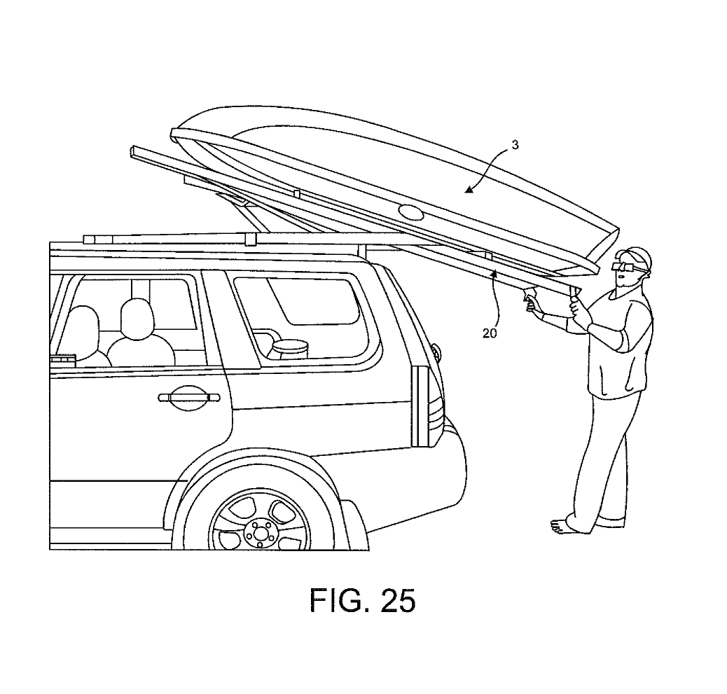

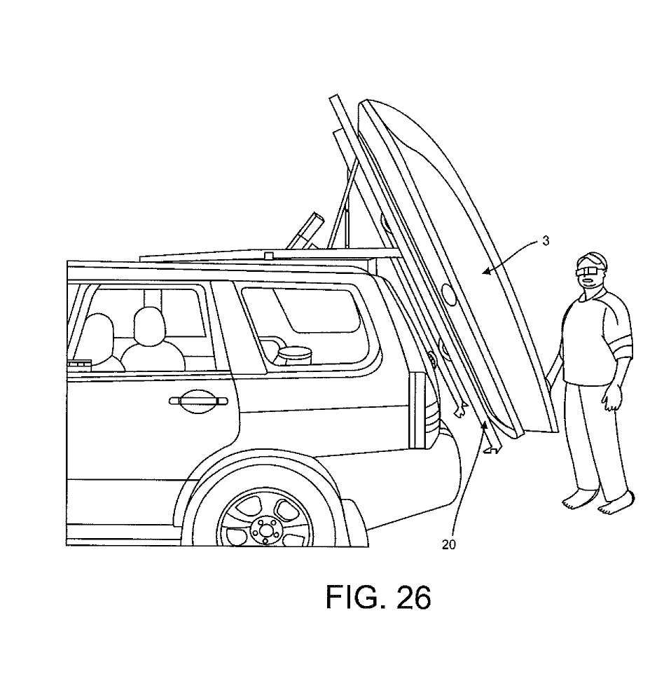

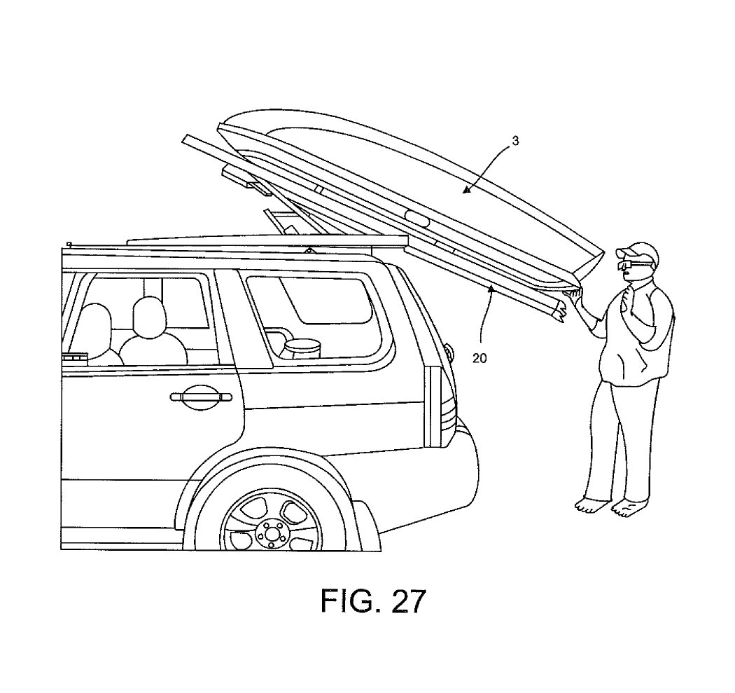

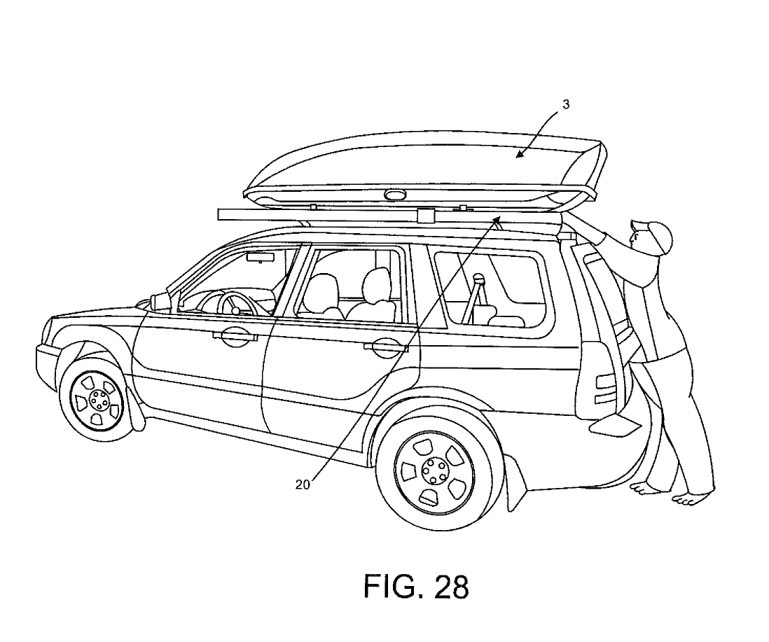

FIG. 24 shows the cargo box 3 being retrieved by pulling the frame 20 towards the rear. As can be seen in FIG. 25 when the cargo boxes 3 centre of mass reaches a set of hinges, the frame 20 tilts from horizontal towards a vertical aspect. The cargo box 3 slides down over the back of the vehicle 2 on rails like shown in FIG. 26. The cargo box 3 comes to a stop at approximately waist-height. As shown in FIG. 27 once the cargo has been removed from the box 3, the cargo frame 20 is lifted until its own weight causes it to tilt and then rotate to horizontal. The cargo frame 20 is then pushed along the roof until it returns to its starting point or home position like that shown in FIG. 28.

In some embodiments (e.g. for particularly tall vehicles) the roof rack 1 has an additional third-tier cargo frame (not shown) that would operate similar to an extension ladder. The roof rack 1 can also be automated (e.g. operated electrically by servo motors such as modern vehicles have servo-driven hatchback doors etc) in some embodiments. It will also be appreciated that the locking system can be augmented by springs instead of being gravity operated.

It will be appreciated that the various parts of the roof rack 1 can be produced in a range of different sizes and from a number of different materials e.g. aluminium, stainless steel, high density plastic etc. It will also be appreciated that the roof rack 1 can be made in a number of different ways.

The roof rack 1 has a number of benefits and advantages over known roof racks. The roof rack 1 improves the safety and convenience during loading and unloading of cargo from the roof of a vehicle and to reduce damage to the vehicle. The roof rack 1 does not require the vehicle to be modified before installing it. The roof rack 1 is rear loading which is an advantage over side loading roof racks as these can be very difficult to use in places such as ski area parking lots where vehicles are parked close together. The roof rack 1 does not have pivot points fixed beyond the rear of the vehicle like some roof racks which prevents vertically ascending hatchback type doors from fully opening. The roof rack 1 also controls the cargos rate of descent and stops the cargo crashing into the back or roof of the vehicle.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the platform, clamps, carriers, tilt and load assembly, cargo frame, cargo, rear lock assembly, zee-locks, rear tilt guide, forward pivot guides etc may vary dependent on the particular application for which it is used without variation in the spirit and scope of the present invention.

In addition, although the preferred embodiments described herein are directed to a roof rack, it will be appreciated by those skilled in the art that variations and modifications are possible within the scope of the appended claims.

1. A roof rack for a vehicle having:
roof attachment means;
a cargo frame adapted to releasably engage with cargo;
means to enable the cargo frame to be moved between a substantially horizontal position above the roof of a vehicle and a substantially vertical position behind the vehicle; and
means to control the rate of descent or ascent of the cargo frame;
the roof rack adapted such that in use the roof rack is attached to the roof of a vehicle via the roof attachment means and wherein a user standing behind the vehicle is able to pull the cargo frame or attached cargo towards himself such that the cargo frame and attached cargo controllably moves from a substantially horizontal position above the roof of the vehicle to a substantially vertical position behind the vehicle so that the user can load and/or unload the cargo and once this is done the user can push the cargo frame or attached cargo such that the frame controllably moves from a substantially vertical position behind the vehicle to a substantially horizontal position above the roof of the vehicle.

2. A roof rack according to claim 1, wherein the substantially vertical position of the cargo frame is between about 60 degrees and about 90 degrees.

3. A roof rack according to claim 1, wherein the substantially vertical position of the cargo frame is about 70 degrees.

4. A roof rack according to claim 1, wherein the means to control the rate of descent or ascent is controlled by a tilt and load control assembly.

5. A roof rack according to claim 1, wherein the means to control the rate of descent or ascent is controlled by a tilt and load control assembly which comprises at least two tilt arms, at least one tilt guide, at least one gas spring and at least one hydraulic damper.

6. A roof rack according to claim 1, wherein the cargo frame has at least one clamp which enables it to releasably engage with the cargo.

7. A roof rack according to claim 1, wherein the roof attachment means comprises a platform having at least two clamps which clamp to the roof or roof rails of a vehicle.

8. A roof rack according to claim 1, wherein the roof attachment means comprises a platform having four clamps which clamp to the roof rails of a vehicle.

9. A roof rack according to claim 1, wherein the roof attachment means comprises a platform having two elongate members which run lengthwise of the roof of the vehicle when installed and also having two elongate members connecting the lengthwise elongate members and further having four clamps attached to the lengthwise elongate members which clamp to the roof rails of a vehicle.

10. A roof rack according to claim 1, wherein the cargo frame comprises two elongate members which run lengthwise of the roof of the vehicle when installed and also having three elongate members connecting the lengthwise members and also having cargo attaching means.

11. A roof rack according to claim 1, having a rear lock assembly which when locked prevents the cargo frame from moving.

12. A roof rack according to claim 1, having a rear lock assembly which when locked prevents the cargo frame from moving, the rear lock assembly comprising at least one jump-stopper, at least one hook-lock, at least one cam and at least one drop lock.

13. A roof rack according to claim 1, wherein the cargo comprises a cargo box which houses equipment and is adapted such that it can be moved between an open configuration and a closed configuration.
